(19) United States
(12) Patent Application Publication
(10) Pub. No.: US 2009/0190652 A1
(43) Pub. Date: Jul. 30, 2009

(54) SYSTEM AND METHOD FOR CONTROLLING TRANSMISSION OF MOVING IMAGE DATA OVER NETWORK

(76) Inventor: Yong-Hwa Kim, Incheon-Shi (KR)

Correspondence Address: DICKSTEIN SHAPIRO LLP, 1825 EYE STREET NW, Washington, DC, 20006-5403, US

(21) Appl. No.: 12/089,515

(22) PCT Filed: Oct. 6, 2005
(86) PCT No.: PCT/KR2005/003301

§ 371 Date: Aug. 21, 2008

(51) Int. Cl. H04N 11/04

(52) U.S. Cl. 375/240.01; 375/E07.001

(57) ABSTRACT

The present invention relates to a system and method for controlling the transmission of moving image data through a network. The system for controlling the transmission of moving image data through a network of the present invention includes a server and a client. The server transmits key frames and delta frames of a compressed moving image stream in a form of packets through a multimedia communication network, and controls interruption of transmission of subsequent delta frames and continuation of transmission only from a subsequent key frame, depending on whether a specific delta frame is lost, based on a response signal indicating reception of each packet. The client receives packets corresponding to the key frames and the delta frames, obtained from the compressed moving image stream, from the server, and transmits the response signal indicating reception of each packet to the server.

### FIELD OF THE INVENTION

The present invention relates, in general, to a system and method for controlling the transmission of moving image data through a network and, more particularly, to a system and method for controlling the transmission of moving image data through a network, which can minimize the degradation of moving image quality caused by frame loss from moving image data that is transmitted through a multimedia communication network, such as the Internet.

### BACKGROUND

As well known to those skilled in the art, in the case of a multimedia communication network such as the Internet, as a network using a Digital Subscriber Line (xDSL) or dedicated line that is capable of transmitting large amounts of data and has an improved data transfer rate has been constructed, the necessity for service of transmitting large amounts of data, such as moving image broadcasts, has increased.

In order to satisfy the necessity for service of transmitting large amounts of data, such as moving image broadcasts, multimedia data compression technology, such as Moving Picture Experts Group 1 (MPEG1), MPEG 2, MPEG 4, or MPEG 7, has been proposed and utilized as standards for suitably compressing and efficiently transmitting digital moving image data, as a result of promotion of the development of multimedia technology.

Such MPEG technology is adapted to individually compress video data and audio data of a moving image and transmit the compressed video and audio data in the form of packets in a streaming manner through a network. Video data are classified into I frames used as key frames that contain information about actual pictures of video data, and P and B frames used as delta frames that contain motion information, such as a correlation between respective key frames, and are constructed to allow respective frames to be compressed in both directions and data to be aligned.

Meanwhile, in MPEG 1, one key frame is created every second, and in MPEG 4, one key frame is created every four to five seconds. As shown in FIG. 1, MPEG moving image data, transmitted through a network, is constructed so that the data can be created and transmitted in packets, and I, P and B frame data, having 20 to 30 frames per packet, can typically be included as payload data. The size of one payload can be automatically determined through a Transmission Control Protocol (TCP). However, if the size of one packet is greater than a standard packet size defined by the protocol, the packet is divided into a plurality of payloads and transmitted.

MPEG moving image data, transmitted in the form of packets through a network, are constructed so that they are transmitted while maintaining a data alignment sequence in the sequence of I, P and B frames, which are reference criteria for the compression of a moving image. At the time of transmitting moving image packets, if an I frame, which is a key frame, is not normally received by a client that is a reception side, P and B frames, which are delta frames related to the I frame, undergo serious data loss, thus resulting in the degradation of image quality during the play of the entire video.

Further, if a specific delta frame in a packet is lost when the frames of moving image data are transmitted in the form of the packet through a network, as shown in FIG. 2, there is a problem in that loss occurs upon correlation between subsequent delta frames, to be transmitted after the specific delta frame, and a key frame, so that it is not only impossible to use the subsequent delta frames but also difficult to normally play a subsequent key frame, thus increasing the degradation of image quality during the play of video.

Accordingly, the present invention has been made keeping in mind the above problems occurring in the prior art, and an object of the present invention is to provide a system and method for controlling the transmission of moving image data through a network, which minimize the degradation of video quality caused by the loss of a delta frame from moving image data that is transmitted through a network.

Another object of the present invention is to provide a system and method for controlling the transmission of moving image data through a network, which do not transmit delta frames between a lost delta frame and a subsequent key frame if the lost delta frame is not transmitted due to the loss thereof within a valid time period that is based on the key frame of moving image data transmitted through the network, thus minimizing the degradation of video quality.

A further object of the present invention is to provide a system and method for controlling the transmission of moving image data through a network, which can create respective frames of a moving image in packet form and transmit the individual packets so as to determine a valid transmission time period for the moving image frames and selectively transmit the moving image frames.

In order to accomplish the above objects, the present invention provides a system for controlling transmission of moving image data through a network, comprising a server for transmitting key frames and delta frames of a compressed moving image stream in a form of packets through a multimedia communication network, and controlling interruption of transmission of a subsequent delta frame and transmission only from a subsequent key frame, depending on whether a specific delta frame is lost, based on a response signal indicating reception of each packet, and a client for receiving packets corresponding to the key frame and the delta frame, obtained from the compressed moving image stream, from the server, and transmitting the response signal indicating reception of each packet to the server.

Further, in order to accomplish the above objects, the present invention provides a method of controlling transmission of moving image data through a network, comprising the steps of a server transmitting key frames and delta frames of a compressed moving image stream to a client in a form of packets, the client transmitting a response signal indicating reception of each moving image packet, the server determining whether transmission of a specific delta frame is valid, based on the response signal received from the client, and determining to interrupt transmission of a subsequent delta frame and to transmit only from a subsequent key frame if it is determined that the transmission of the specific delta frame is not valid.

According to the present invention, there is an advantage in that moving image frames corresponding to key frames and delta frames are created in the form of individual packets and transmitted when a server transmits an MPEG moving image stream to a client through a network, and whether the transmission of a delta frame is completed by a transmission deadline is determined based on the transmission time period, duration and presentation time period of a key frame packet, so that, if a specific delta frame is not normally transmitted by the transmission deadline, the transmission of delta frames between the specific delta frame and a subsequent key frame can be interrupted, thus minimizing the degradation of video quality due to the loss of a delta frame during the transmission of an MPEG moving image stream through a network.

### BRIEF DESCRIPTION OF THE DRAWINGS

FIG. 1 is a view showing the format of the conventional packet transmission of moving image data frames through a network;

FIG. 2 is a view showing the conventional unusable state of subsequent delta frames caused by the loss of a delta frame from moving image data packet transmitted through a network;

FIG. 3 is a view showing a state in which moving image frames are individually packetized, based on a method of controlling the transmission of moving image data through a network according to the present invention;

FIG. 4 is a diagram showing the construction of a system for controlling the transmission of moving image data through a network according to the present invention;

FIG. 5 is a view showing an example of a state in which subsequent delta frames are not transmitted due to the loss of a specific delta frame during the transmission of individually packetized moving image data frames according to an embodiment of the present invention; and

FIG. 6 is a flowchart of a method of controlling the transmission of moving image data through a network according to the present invention.

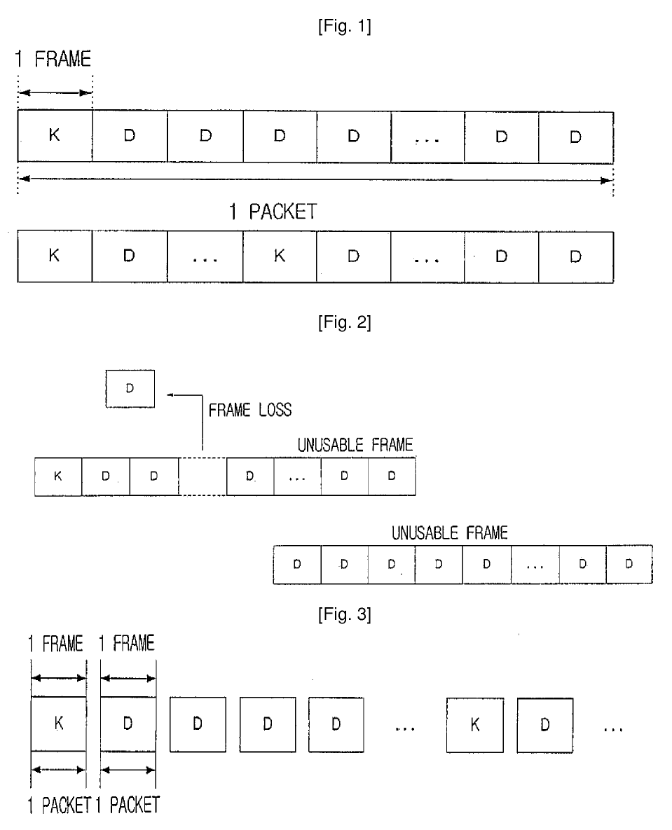

DESCRIPTION OF REFERENCE CHARACTERS
OF IMPORTANT PARTS

| | |
|---|---|
| 10: moving image reception unit | 15: moving image encoding unit |
| 20: frame alignment unit | 25, 65: stream buffer |
| 30: packet creation unit | 35: packet transmission control unit |
| 40: packet transmission unit | 45: response reception unit |
| 50: packet reception control unit | 55: packet reception unit |
| 60: response transmission unit | 70: frame reconstruction unit |
| 75: moving image decoding unit | 80: moving image play unit |
| 85: network transmission unit | 100: server |
| 200: client | |

Hereinafter, embodiments of the present invention will be described in detail with reference to the attached drawings.

FIG. 3 is a view showing a state in which moving image frames are individually packetized, based on a method of controlling the transmission of moving image data through a network according to the present invention.

As shown in FIG. 3, in an embodiment of the present invention, a key frame (I frame) and delta frames (P and B frames) of MPEG data, which is moving image data, can be packetized into individual packets and can be sequentially transmitted through a network, based on transmission packets corresponding to the I, P and B frames.

That is, one frame of MPEG moving image data is implemented in one packet, which is composed of header information, payload parsing information and payload data. A payload stream number of each packet includes an audio number, a key frame, key frame/delta frame identification information, and presentation time.

The presentation time, included in the header information of the key frame packet, is used as the basis for calculating a valid transmission time period for a subsequent delta frame packet to be transmitted. Status, indicating the normal transmission of subsequent delta frames and a key frame, or the interruption of transmission of subsequent delta frames and the continuation of transmission only from a key frame, is determined depending on whether the delta frame has been transmitted within the valid transmission time.

Meanwhile, a server for transmitting the MPEG moving image data to a client determines a transmission deadline as the valid transmission time period for the frame, and then determines whether each frame is validly transmitted. The expression for determining the transmission deadline is indicated in the following Equation [1].

transmission deadline=(presentation time period−buffering time period)+transmission start time point. [Equation 1]

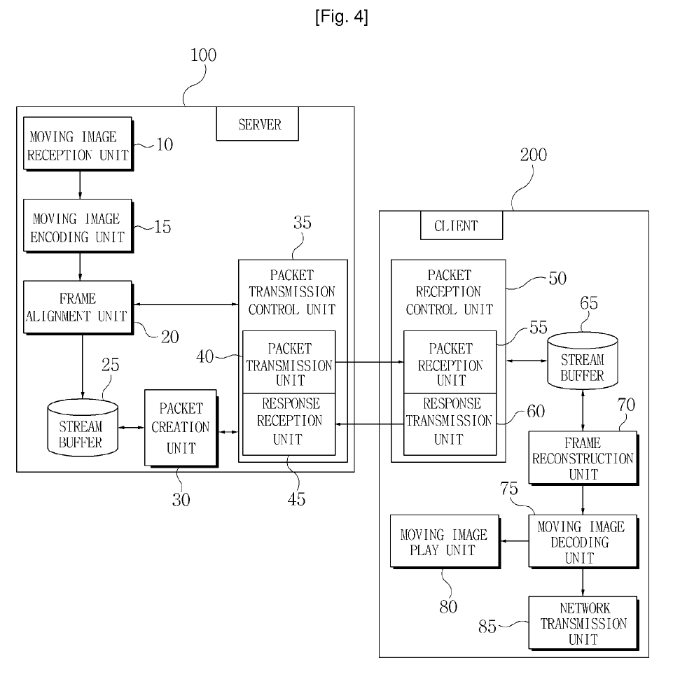

Next, FIG. 4 is a diagram showing the construction of a system for controlling the transmission of moving image data through a network according to the present invention.

As shown in FIG. 4, the system for controlling the transmission of moving image data according to the present invention includes a server 100 and a client 200. The server 100 includes a moving image reception unit 10, a moving image encoding unit 15, a frame alignment unit 20, a stream buffer 25, a packet creation unit 30, and a packet transmission control unit 35.

Further, the client 200 includes a packet reception control unit 50, a stream buffer 65, a frame reconstruction unit 70, a moving image decoding unit 75, a moving image play unit 80 and a network transmission unit 85.

In the server 100, the moving image reception unit 10 receives an MPEG-format moving image data stream created by a separate multimedia server (preferably, a Windows media server).

The moving image encoding unit 15 encodes the MPEG-format moving image stream, received from the moving image reception unit 10, and divides the MPEG-format moving image stream into an I frame, which is a key frame, and P and B frames, which are delta frames. The frame alignment unit 20 aligns moving image frames, which have been encoded and divided into frames by the moving image encoding unit 15, with respect to each transmission time point. This alignment is performed based on the transmission deadline for each frame calculated in the above Equation [1].

The stream buffer 25 buffers the encoded moving image frames in the sequence of the moving image frames, aligned with respect to each transmission time point by the frame alignment unit 20, through the alignment of a queue. The packet creation unit 30 packetizes the moving image frames corresponding to the key frame and the delta frames, output from the stream buffer 25, into individual packets.

The packet transmission control unit 35 transmits the packet data of the moving image frames, which are individually packetized by the packet creation unit 30, to the client through a multimedia communication network, such as the Internet, and controls the continuation or interruption of transmission depending on whether packets corresponding to the delta frames are normally transmitted by a transmission deadline for the key frame in response to a response signal (ACK) received from the client 200 with respect to each packet.

The packet transmission control unit 35 includes a packet transmission unit 40 for transmitting respective packets to the client 200 in the frame alignment sequence determined by the frame alignment unit 20, through the multimedia communication network in a Transmission Control Protocol/Internet Protocol (TCP/IP) or User Datagram Protocol (UDP) environment, and a response reception unit 45 for receiving a response signal, transmitted from the client 200 with respect to each packet as a result of transmission of the frame packets.

The packet transmission control unit 35 determines whether a delta frame packet is normally received in response to a response signal received by the response reception unit 45, based on a transmission deadline that is calculated using a transmission start time point, at which a packet is transmitted by the packet transmission unit 40, a presentation time period included in the key frame packet, and the buffering time period of a reception side. If a delta frame packet is normally transmitted by the transmission deadline after a previous key frame packet has been transmitted, subsequent delta frame packets and a subsequent key frame are sequentially transmitted as usual.

In contrast, if the delta frame subsequent to the key frame is not validly transmitted by the transmission deadline, the packet transmission control unit 35 determines that the corresponding delta frame has been lost, interrupts the transmission of delta frames subsequent to the lost delta frame, and transmits a subsequent key frame and subsequent delta frames.

Further, in the client 200, the packet reception control unit 50 includes a packet reception unit 55 for receiving frame packets from the packet transmission control unit 35 of the server 100 through the multimedia communication network, and a response transmission unit 60 for transmitting a corresponding response signal to the server 100 whenever the packet reception unit 55 receives a packet.

The stream buffer 65 sequentially buffers the key frame packets and the delta frame packets, received through the packet reception unit 55 of the packet reception controller 50. The frame reconstruction unit 70 reconstructs frame data by converting respective frame packets, output from the stream buffer 65, into the key frames and the delta frames.

The moving image decoding unit 75 decodes the reconstructed key frames and delta frames into the form of moving image stream data that is transmittable through a network and is playable. The moving image play unit 80 executes video signal processing with respect to the decoded moving image stream data, and allows the video signal-processed results to be played through a monitor screen provided on the client 200.

The network transmission unit 85 transmits the moving image stream data, decoded by the moving image decoding unit 75, to a specific local client through the network so that the corresponding client 200 can be used as a relay client.

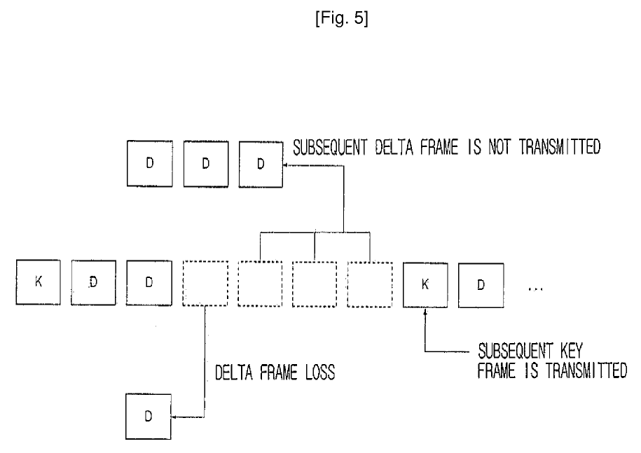

Meanwhile, as shown in FIG. 5, if a specific delta frame packet is lost when delta frame packets are transmitted after a key frame packet has been transmitted, and thus a response signal indicating the reception of the delta frame packet is not received by the transmission deadline, both the server 100 and the client 200 are operated to interrupt the transmission of delta frame packets to be transmitted prior to a subsequent key frame packet, and transmit the subsequent key frame packet to the client 200.

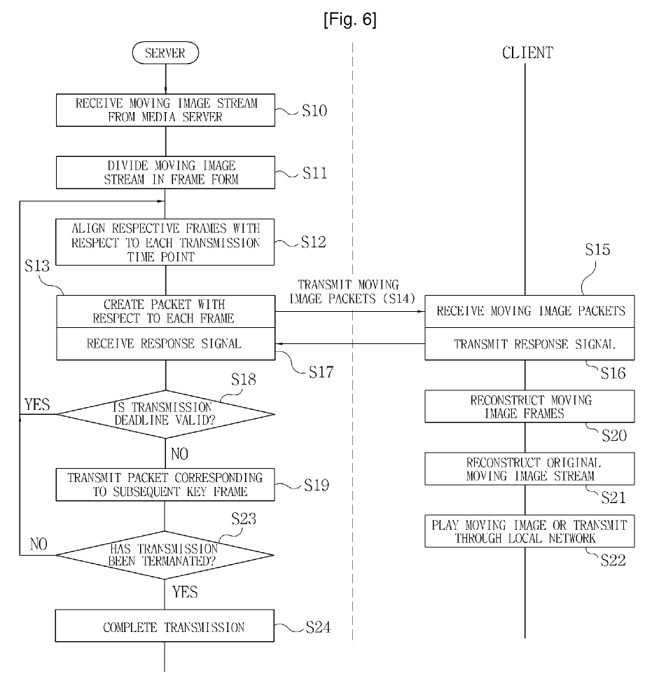

Hereinafter, the operation of the present invention having the above construction is described in detail with reference to the flowchart of FIG. 6.

First, the moving image reception unit 10 of the server 100 receives MPEG moving image stream data from a separate media server at step S10. The moving image encoding unit 15 encodes the received moving image stream data and divides the moving image stream data in the form of a key frame and a delta frame at step S11.

In this state, the frame alignment unit 20 of the server 100 sequentially aligns the moving image frames with respect to each transmission time point at step S12. The packet creation unit 30 individually packetizes the moving image frames, output from the stream buffer 25, into packets with respect to respective frames at step S13.

The packet transmission control unit 35 of the server 100 transmits moving image packets, obtained by packetizing the moving image frames with respect to respective frames through the packet transmission unit 40, to the client 200 through the multimedia communication network at step S14. The packet reception control unit 50 of the client 200 receives the frame packets from the server 100 through the packet reception unit 55 at step S15.

The packet reception control unit 50 of the client 200 transmits a response signal through the response transmission unit 60 whenever it receives a key frame packet or delta frame packet through the packet reception unit 55 at step S16. The response reception unit 45 of the packet transmission control unit 35 receives the response signal from the client 200, thus determines whether a transmitted frame packet has been normally received by the transmission deadline at step S17.

Meanwhile, the packet transmission control unit 35 of the server 100 determines whether each delta frame packet subsequent to the transmission of the key frame packet has been transmitted by the transmission deadline at step S18.

As a result of the determination, if the packet transmission control unit 35 determines that each delta frame packet has been validly transmitted by the transmission deadline, the procedure ranging from step S13 to step S17 is repeated, so that the transmission of subsequent delta frame packets and a subsequent key frame packet is normally performed.

However, if it is determined that the transmission deadline for a specific delta frame packet has passed at step S18, the transmission of a subsequent delta frame packet is interrupted, and only a subsequent key frame packet is transmitted at step S19.

In this state, the client 200 reconstructs the moving image packets, received through the packet reception unit 55 and output from the stream buffer 65, in the form of respective frames through the reconstruction unit 70 at step S20. The moving image decoding unit 75 decodes respective moving image frames, reconstructed by the frame reconstruction unit 70, and converts the moving image frames into an original moving image stream at step S21.

In this case, the client 200 allows the moving image play unit 80 to execute video signal processing with respect to the moving image stream and to play the video signal-processed results through the monitor, or allows the network transmission unit 85 to transmit the moving image stream to a desired local side through the network at step S22.

Next, the server 100 determines whether the transmission of the corresponding moving image stream has been terminated at step S23. If it is determined that the transmission of the corresponding moving image stream has been terminated, the transmission of moving image packets performed through the packet transmission control unit 35 is terminated at step S24.

Those skilled in the art will appreciate that the present invention is not limited to the preferred embodiments of the present invention, but various improvements, modifications, additions and substitutions are possible, without departing from the scope and spirit of the invention as disclosed in the accompanying claims. It should be noted that if the improvements, modifications, additions and substitutions belong to the scope of the accompanying claims of the present invention, the technical spirit thereof also belongs to the present invention.

What is claimed as new and desired to be protected by Letters Patent of the United States is:

1. A system for controlling transmission of moving image data through a network, comprising:
a server for transmitting key frames and delta frames of a compressed moving image stream in a form of packets through a multimedia communication network, and controlling interruption of transmission of subsequent delta frames and continuation of transmission only from a subsequent key frame, depending on whether a specific delta frame is lost, based on a response signal indicating reception of each packet; and
a client for receiving packets corresponding to the key frame and the delta frame, obtained from the compressed moving image stream, from the server, and transmitting the response signal indicating reception of each packet to the server.

2. The transmission control system according to claim 1, wherein the compressed moving image stream is a moving image stream to which a Moving Picture Experts Group (MPEG)-format compression algorithm is applied.

3. The transmission control system according to claim 2, wherein the server is constructed to packetize moving image frames corresponding to the key frames and the delta frames into individual packets.

4. The transmission control system according to claim 3, wherein each of the packets includes header information containing a packet number, key frame/delta frame identification information, a transmission time, a duration and a presentation time, and payload information containing a single key frame or delta frame.

5. The transmission control system according to claim 3, wherein the server comprises:
a moving image reception unit for receiving the compressed moving image stream from a separate media server;
a moving image encoding unit for encoding the compressed moving image stream and dividing the moving image stream into moving image frames corresponding to the key frames and the delta frames;
a frame alignment unit for aligning the key frames and the delta frames with respect to each transmission time point;
a buffer for buffering the moving image frames, aligned with respect to each transmission time point, through alignment of a queue;
a packet creation unit for packetizing the key frames and the delta frames into individual packets; and
a packet transmission control unit for sequentially transmitting the key frame packets and the delta frame packets to the client in a sequence aligned with respect to each transmission time point, determining whether a specific delta frame packet is lost based on a response signal received from the client and determining interruption of transmission of subsequent delta frame and continuation of transmission only from a subsequent key frame packet.

6. The transmission control system according to claim 5, wherein the packet transmission control unit performs a control operation to interrupt transmission of the subsequent delta frame and to transmit only from the key frame if transmission of the specific delta frame is not valid when a predetermined transmission deadline is passed.

7. The transmission control system according to claim 4, wherein the transmission deadline is determined using the following equation:
transmission deadline=(presentation time period−buffering time period)+transmission start time point.

8. The transmission control system according to claim 6, wherein the transmission deadline is determined using the following equation:
transmission deadline=(presentation time period−buffering time period)+transmission start time point.

9. The transmission control system according to claim 1, wherein the client comprises:
a packet reception control unit for receiving the key frame packets and the delta frame packets from the server and transmitting a response signal, indicating reception of each packet, to the server;
a buffer for buffering the received moving image frame packets;
a frame reconstruction unit for reconstructing the key frame packets and the delta frame packets in the form of moving image frames;
a moving image decoding unit for decoding the moving image frames and converting the moving image frames into a moving image stream; and
a moving image output unit for outputting the compressed moving image stream to be played or to be transmitted through a local network.

10. The transmission control system according to claim 3, wherein the client comprises:
a packet reception control unit for receiving the key frame packets and the delta frame packets from the server and transmitting a response signal, indicating reception of each packet, to the server;
a buffer for buffering the received moving image frame packets;
a frame reconstruction unit for reconstructing the key frame packets and the delta frame packets in the form of moving image frames;
a moving image decoding unit for decoding the moving image frames and converting the moving image frames into a moving image stream; and
a moving image output unit for outputting the compressed moving image stream to be played or to be transmitted through a local network.

11. A method of controlling moving image data through a network, comprising:
a first step of a server transmitting a key frame and a delta frame of a compressed moving image stream to a client in a form of packets;
a second step of the client transmitting a response signal indicating reception of each moving image packet;
a third step of the server determining whether transmission of a specific delta frame is valid, based on the response signal received from the client; and
a fourth step of determining to interrupt transmission of subsequent delta frames and to continue transmission only from a subsequent key frame if it is determined that the transmission of the specific delta frame is not valid.

12. The control method according to claim 11, wherein the first step is constructed to apply a Moving Picture Experts Group (MPEG)-format compression algorithm to the compressed moving image stream.

13. The control method according to claim 12, wherein the first step is constructed to packetize moving image frames corresponding to the key frame and the delta frame into individual packets.

14. The control method according to claim 13, wherein the first step comprises the steps of:
receiving the compressed moving image stream from a separate media server;
encoding the compressed moving image stream and dividing the compressed moving image stream into moving image frames corresponding to the key frames and the delta frames;
aligning the key frames and the delta frames with respect to each transmission time point and buffering the aligned key frames and delta frames;
packetizing the key frames and the delta frames into individual packets; and
sequentially transmitting the key frame packets and the delta frame packets to the client in a sequence aligned with respect to each transmission time point.

15. The control method according to claim 11, wherein the third step is performed to determine whether the specific delta frame has been validly transmitted by the predetermined transmission deadline.

16. The control method according to claim 15, wherein the transmission deadline is determined using the following equation:
transmission deadline=(presentation time period−buffering time period)+transmission start time point.
